(19) United States
(12) Patent Application Publication
(10) Pub. No.: US 2024/0388044 A1
(43) Pub. Date: Nov. 21, 2024

(54) HIGH CURRENT TERMINAL FOR ELECTRONIC CIRCUIT PROTECTION

(71) Applicant: SMART Electronics Inc, Ulsan (KR)

(72) Inventors: Sang Joon JIN, Busan (KR); Dong Ho JEON, Busan (KR); Saeng Soo YUN, Yangsan-si (KR)

(73) Assignee: SMART Electronics Inc, Ulsan (KR)

(21) Appl. No.: 18/663,011

(22) Filed: May 13, 2024

(30) Foreign Application Priority Data
May 19, 2023 (KR) 10-2023-0065049

(51) Int. Cl. H01R 13/696; H01H 85/08

(52) U.S. Cl. CPC H01R 13/696; H01H 85/08; H01H 2229/02

(57) ABSTRACT

A high current terminal for electronic circuit protection includes: a first sectional terminal into which a current flows from the outside; a second sectional terminal transmitting a current flowing inside through the first terminal to the outside; and an element coupled between the first sectional terminal and the second sectional terminal, wherein the element disconnects the first sectional terminal and the second sectional terminal by melting when a current exceeding a preset condition flows inside through the first sectional terminal, and is formed to have a thickness that is equal to or less than thicknesses of the first sectional terminal and the second sectional terminal.

### CROSS REFERENCE TO RELATED APPLICATION

This application claims priority from Republic of Korea Patent Application No. 10-2023-0065049 filed on May 19, 2023, which is hereby incorporated by reference in its entirety.

### BACKGROUND

### Field

The present disclosure relates to a terminal for electronic circuit protection and, in more detail, a high current terminal for electronic circuit protection that protects a circuit connected with the terminal from an overcurrent by disconnecting the terminal when an overcurrent flows.

### Related Art

Recently, it has been being discussed to improve the reliability of electric devices and it is increasingly required to design electronic devices with high reliability against continuous accidents by electronic devices closely related to our life.

A fuse that disconnects the flow of current when an abnormal overcurrent or a high temperature is generated in the circuit of electronic products, etc. were developed as such safety parts.

In general, a fuse is an overcurrent protection device for an electric circuit and is generally used to protect power systems and prevent damage to components related to a circuit when specific circuit conditions are caused. When a fusible element or assembly is coupled between terminal elements of a fuse and a specific circuit condition is caused, the fusible element or assembly breaks, melts, or if not, structurally breaks down, thereby opening the current path between the fuse terminals. Accordingly, line side circuitry is electrically separated from load side circuitry by the fuse, so it is possible to prevent damage to the load side circuitry from an overcurrent condition.

However, it is required to improve circuit protection devices such as an electric fuse in consideration of variation accompanying continuous development of power systems.

As technical documents about an overcurrent circuit protection device in the related art, there are Korean Patent No. 10-1179546 that discloses a repeatable fuse that prevents overheating and prevents an overcurrent from flowing in a circuit using an elastic member and Korean Patent No. 10-1514956 that discloses a complex fuse for preventing overheating and an overcurrent using a solder ball and an elastic body for preventing electrical connection.

However, circuit protection devices of the related art have different shapes and structures, depending on the range and purpose of use, so there is a problem in that it is difficult to manufacture such circuit protection elements for general purpose using minimum manufacturing facilities.

Therefore, in order to solve the problems described above, it is required to implement a terminal for circuit protection that can safely and quickly protect an electric circuit from an overcurrent and can be used for general purpose.

### SUMMARY

An objective of the present disclosure is to provide a high current terminal for electronic circuit protection that includes a fusible element between sectional terminals and can be used for general purpose by combining materials and shapes for the element on the basis of the purpose of use because a resistance value and a melting point are determined on the basis of the material and the shape of the element.

Objectives of the present disclosure are not limited to the objectives described above and other objectives of the present disclosure not stated herein would be clearly understood by those skilled in the art from the following description.

A high current terminal for electronic circuit protection according to an embodiment of the present disclosure includes: a first sectional terminal into which a current flows from the outside; a second sectional terminal transmitting a current flowing inside through the first terminal to the outside; and an element coupled between the first sectional terminal and the second sectional terminal, wherein the element disconnects the first sectional terminal and the second sectional terminal by melting when a current exceeding a preset condition flows inside through the first sectional terminal, and is formed to have a thickness that is equal to or less than thicknesses of the first sectional terminal and the second sectional terminal.

Further, a preset pattern is formed on a surface of the element and the pattern is any one of a line trimming pattern, a double line trimming pattern, a circular hole pattern, an elliptical hole pattern, and a Z-line trimming pattern.

Further, the element is coupled between the first sectional terminal and the second sectional terminal through any one manner of E-beam welding, hot-rolling bonding, cold-rolling bonding, and laser welding.

Further, the element includes: a first metal layer provided to have a preset thickness; and a second metal layer provided on a top of the first metal layer and made of a different material from the first metal layer.

Further, the second metal layer is formed on the top of the first metal layer through at least any one method of dipping plating, metal melting and pouring, metal dip coating, electroplating, and chemical plating, reduces disconnection time between the first sectional terminal and the second sectional terminal when a melting point of the second metal layer is lower than a melting point of the first metal layer, and delays the disconnection time between the first sectional terminal and the second sectional terminal when the melting point of the second metal layer is higher than the melting point of the first metal layer.

According to the present disclosure, the present disclosure includes an element that can melt between sectional terminals, and a resistance value and a melting point are determined on the basis of the material and shape of the element, so the present disclosure has an effect of being able to be used for general purpose by combining materials and shapes for the element on the basis of the purpose of use.

### BRIEF DESCRIPTION OF THE DRAWINGS

FIG. 1 and FIG. 2 are configuration diagrams of a high current terminal for electronic circuit protection according to an embodiment of the present disclosure.

FIG. 3 and FIG. 4 are diagrams illustrating elements of the high current terminal for electronic circuit protection according to an embodiment of the present disclosure.

FIG. 5 is a maximum temperature variation graph of an element having a line trimming pattern of the high current terminal for electronic circuit protection according to an embodiment of the present disclosure.

FIG. 6 is a maximum temperature variation graph of an element having a circular hole pattern of the high current terminal for electronic circuit protection according to an embodiment of the present disclosure.

FIG. 7 is a graph illustrating maximum temperatures of materials of the element of the high current terminal for electronic circuit protection according to an embodiment of the present disclosure.

FIG. 8 is a graph illustrating temperature rise slopes of materials of the element of the high current terminal for electronic circuit protection according to an embodiment of the present disclosure.

FIG. 9 is a graph illustrating resistance value variations of materials of the element of the high current terminal for electronic circuit protection according to an embodiment of the present disclosure.

### DESCRIPTION OF EXEMPLARY EMBODIMENTS

Details including the technical problem, the technical solution, and the effects described above are included in the embodiments and drawings to be described hereafter. The advantages and features of the present disclosure, and methods of achieving them will be clear by referring to the exemplary embodiments that will be describe hereafter in detail with reference to the accompanying drawings.

The right range of the present disclosure is not limited to the following embodiments and the present disclosure may be changed in various ways by those skilled in the art without departing from the scope of the present disclosure.

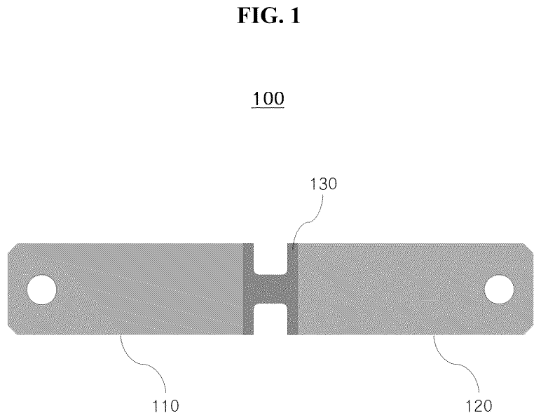

Hereafter, a high current terminal for electronic circuit protection of the present disclosure is described in detail with reference to FIG. 1.

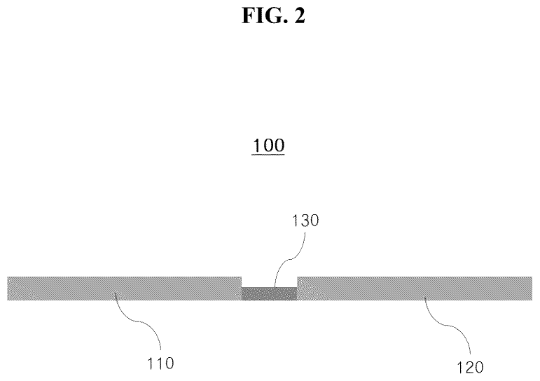

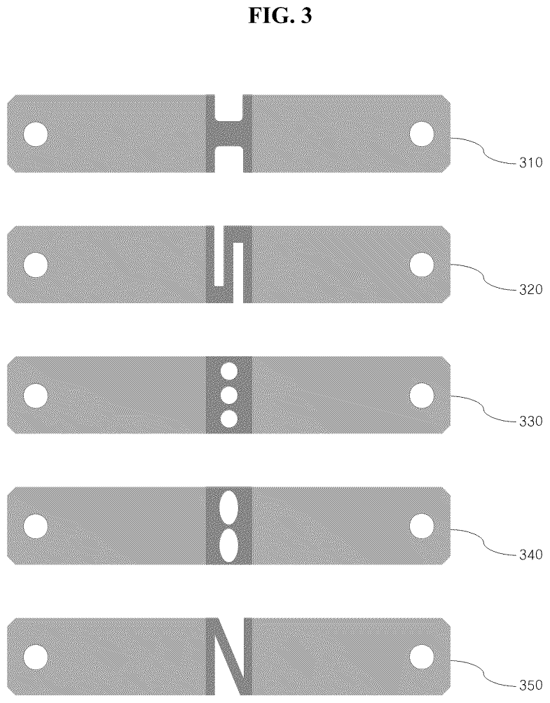

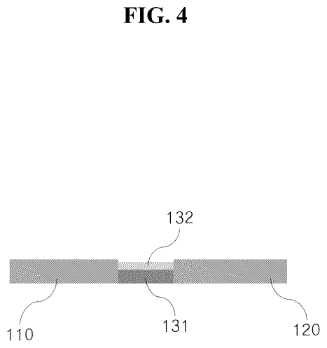

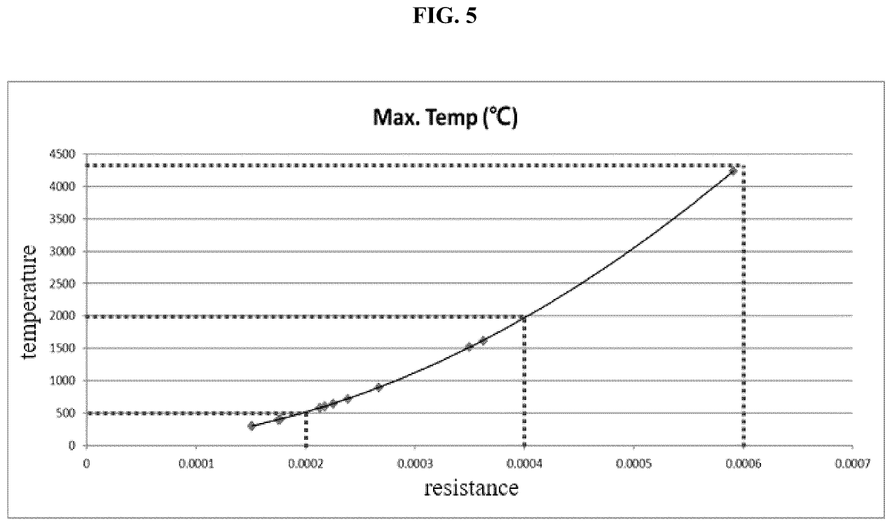

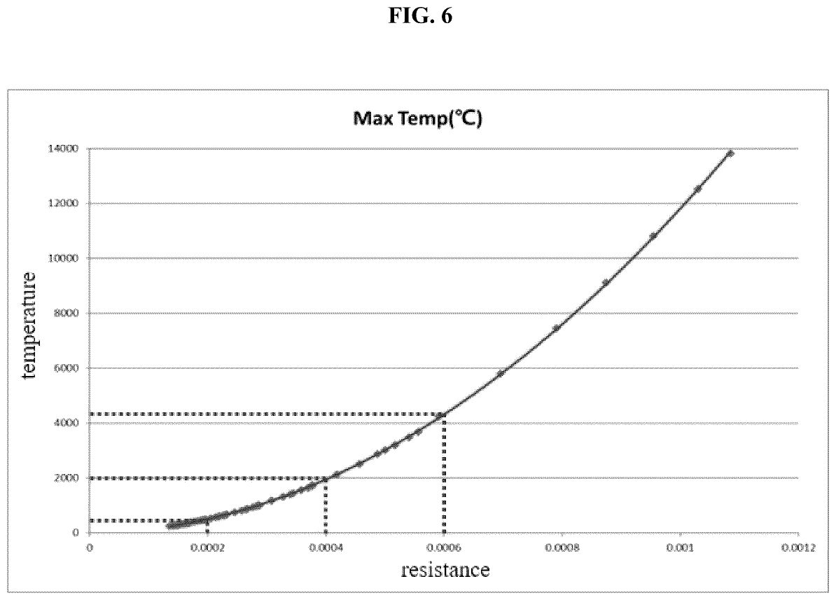

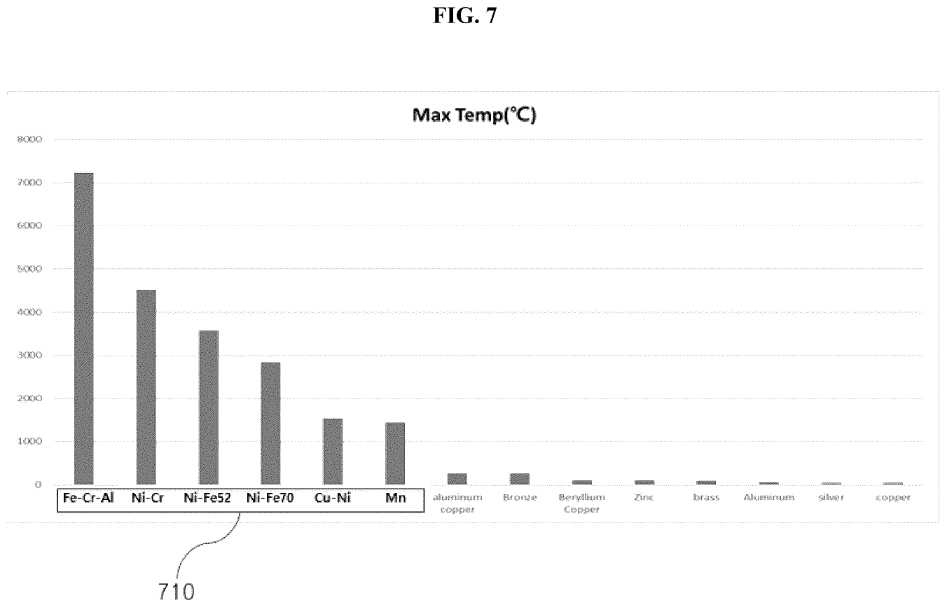

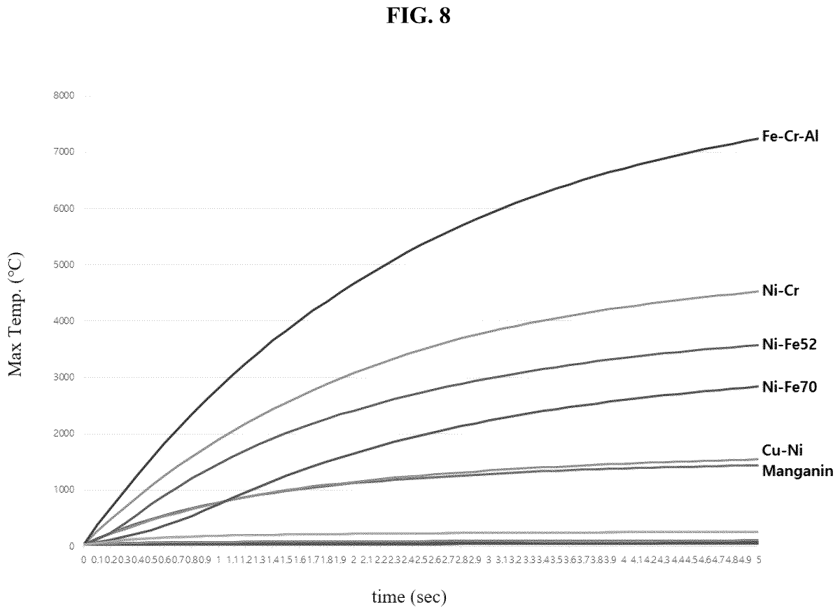

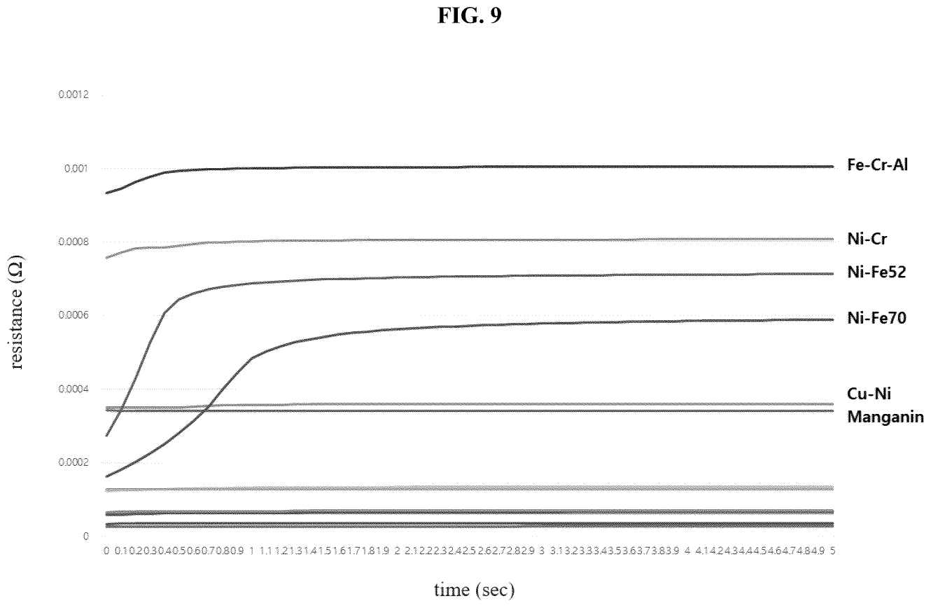

FIG. 1 and FIG. 2 are configuration diagrams of a high current terminal for electronic circuit protection according to an embodiment of the present disclosure, FIG. 3 and FIG. 4 are diagrams illustrating elements of the high current terminal for electronic circuit protection according to an embodiment of the present disclosure, FIG. 5 is a maximum temperature variation graph of an element having a line trimming pattern of the high current terminal for electronic circuit protection according to an embodiment of the present disclosure, FIG. 6 is a maximum temperature variation graph of an element having a circular hole pattern of the high current terminal for electronic circuit protection according to an embodiment of the present disclosure, FIG. 7 is a graph illustrating maximum temperatures of materials of the element of the high current terminal for electronic circuit protection according to an embodiment of the present disclosure, FIG. 8 is a graph illustrating temperature rise slopes of materials of the element of the high current terminal for electronic circuit protection according to an embodiment of the present disclosure, and FIG. 9 is a graph illustrating resistance value variations of materials of the element of the high current terminal for electronic circuit protection according to an embodiment of the present disclosure.

### Embodiment 1

Referring to FIG. 1 and FIG. 2, a high current terminal 100 for electronic circuit protection according to an embodiment of the present disclosure may include a first sectional terminal 110, a second sectional terminal 120, and an element 130.

The first sectional terminal 110 provides a path through which a current flows inside from the outside, the second sectional terminal 120 provides a path through which a current flowing inside through the first sectional terminal 110 is transmitted to the outside, and the element 130 is coupled between the first sectional terminal 10 and the second sectional terminal 120 and can disconnect the first sectional terminal 110 and the second sectional terminal 120 on the basis of preset conditions.

In this configuration, the element 130 can be coupled between the first sectional terminal 110 and the second sectional terminal 120 through any one manner of E-beam welding, hot-rolling bonding, cold-rolling bonding, and laser welding.

For example, the element 130 may be made of materials such as manganin (CuMnNi), copper nickel (CuNi), iron chrome (FeCrAl), nichrome (NiCr), and nickel iron (NiFe).

Meanwhile, as shown in FIG. 3, the element 130 is formed in a preset pattern on a surface and the pattern may be any one of a line trimming pattern 310 that induces a rise of temperature by one-dimensionally interfering with flow of a current, a double line trimming pattern 320 that induces improved heat generation by making a thin and long line in comparison to the line trimming pattern 310, a circular hole pattern 330 that is structurally stable by forming several circular holes in parallel, an elliptical hole pattern 340 that can be applied when the width of the element 130 is small by improving the circular hole pattern 330, and a Z-line trimming pattern 350 that is structurally stable by diagonally forming a line.

In more detail, since a pattern is formed on the element 130, a current flowing into the first sectional terminal 110 is interfered with, and accordingly, a resistance value increases. Accordingly, when a high current is applied through the first sectional terminal 110, heat is generated at the element 130, the element 130 is melted by the heat, and the first sectional terminal 110 and the second sectional terminal 120 may be disconnected.

In this configuration, as shown in FIG. 5 and FIG. 6, even though different patterns are formed on the surface of the element 130 (other conditions excluding the patterns are all the same), the maximum temperature of the element 130 may be determined on the basis of a resistance value.

That is, a resistance value that is required as a specification can be determined on the basis of a circuit in which the high current terminal 100 for electronic circuit protection is used, etc., and an available maximum temperature can be correspondingly determined.

Referring to FIG. 7, as the result of checking a maximum temperature while changing the material of the element 130 when the pattern of the element 130 is fixed and the intensity of a current that is applied through the first sectional terminal 110 is fixed at 1,000 A, the element 130 can be used at higher temperatures when the material of the element 130 is manganin (CuMnNi), copper nickel (CuNi), iron chrome (FeCrAl), nichrome (NiCr), nickel iron (NiFe), etc. that are resistive materials, as compared with when the material of the element 130 is copper (Cu), silver (Ag), aluminum (Al), etc. that are not resistive materials, and accordingly, it is possible to generate more precise resistance values.

Further, as shown in FIG. 8 and FIG. 9, since the rising slope of temperature depends on the material of the element 130, it is possible to calculate a disconnection time for each material on the basis of the slope. Further, since a resistance value depends on the material of the element 130, it is possible to calculate conditions on application current and time for sections in which variation of a resistance value is generated.

Accordingly, it is possible to calculate an element condition that can reduce or delay a disconnection time of a circuit and to manufacture the high current terminal 100 for electronic circuit protection as a customized circuit protection device to fit to the purpose of use.

Meanwhile, the element 130 disconnects the first sectional terminal 110 and the second sectional terminal 120 by melting when a current (high current) exceeding a preset condition flows inside through the first sectional terminal 110, and the element 130 may be formed to have a thickness equal to or smaller than those of the first sectional terminal 110 and the second sectional terminal 120.

That is, the element 130 is formed to be thinner than the first sectional terminal 110 and the second sectional terminal 120, so it is possible to reduce the disconnection time between the first sectional terminal 110 and the second sectional terminal 120 by inducing quick thermal conduction.

Accordingly, it is also possible to adjust a melting time by adjusting the pattern, thickness, etc. of the element 130 in accordance with the use of the high current terminal 100 for electronic circuit protection.

Meanwhile, as shown in FIG. 4, the element 130 may include a first metal layer 131 provided to have a preset thickness and a second metal layer 132 provided on the top of the first metal layer 131 and made of a different material from the first metal layer 131.

In this configuration, since the second metal layer 132 is provided on the top of the first metal layer 131, there is an effect in that it is possible to reduce the disconnection time of the element 130 and it is possible to suppress dispersion of the disconnection time.

For example, the second metal layer 132 may be made of gold, silver, tin, zinc, aluminum, nickel, platinum, lead, etc. that are metal and alloy plating that have a melting point of 2000° C. or lower.

In more detail, the second metal layer 132 is formed on the top of the first metal layer 131 through at least any one method of dipping plating, metal melting and pouring, metal dip coating, electroplating, and chemical plating. When the melting point of the second metal layer 132 is lower than the melting point of the first metal layer 131, it is possible to reduce the disconnection time between the first sectional terminal 110 and the second sectional terminal 120, and when the melting point of the second metal layer 132 is higher than the melting point of the first metal layer 131, it is possible to delay the disconnection time between the first sectional terminal 110 and the second sectional terminal 120.

### Embodiment 2

Meanwhile, a circuit protection system including the high current terminal 100 for electronic circuit protection may include: a sensor unit that includes at least one temperature sensor and a current sensor measuring a current flowing into the terminal 100 and a current output through the terminal; a first monitoring unit that monitors whether the terminal 100 normally operates on the basis of temperature information collected through the temperature sensor; and a second monitoring unit that determines whether the terminal 100 is disconnected on the basis of current data collected through the current sensor.

In more detail, the first monitoring unit determines reliability of temperature data collected from the temperature sensor of the sensor unit, and when the reliability of the temperature data exceeds a preset first reference value, the second monitoring unit can determine whether the terminal 100 is disconnected by comparing the current flowing into the terminal 100 and the current output through the terminal 100.

Further, when a temperature measured through the at least one temperature sensor of the sensor unit exceeds a preset second reference value, it may be possible to determine that heat is abnormally generated in the circuit protection system and to stop, in an emergency manner, a power supplier that supplies power to the circuit protection system.

Meanwhile, the sensor unit includes a same sensor as a comparison sensor within a preset first reference radius from the temperature sensor and the first monitoring unit may include a data receiver that receives data collected from the measuring sensor (temperature sensor) and the comparison sensor, a time point extractor that extracts a comparison target time point that is a time point at which a measurement value variation ratio of the data collected from the measuring sensor exceeds a preset first ratio, and an error determiner that calculates a sensor failure probability S_{TR} using the comparison target time extracted through the time point extractor.

In this case, the closer the first radius is to the measuring sensor, the higher accuracy the first radius has in comparison, and positions within a radius of 10 mm to 50 mm from the center position of the measuring sensor are ideal. Further, the first ratio may be set as 25% to 30% and the setting may be changed minimally from 10% to maximally to 90%, depending on the kind of the measuring sensor and the surrounding environment.

Further, a method of calculating a measurement value variation ratio of sensing data (temperature data) measured through the temperature sensor subtracts a measurement value Tₜ₁ measured at a time point t₁ of an interval tₐ from a measurement value Tₜ₂ measured at a time point t₂ within the time range of sensing data collected from the temperature sensor, divides the value obtained subtraction by a measurement value Tₜ₁, and takes an absolute value by multiplying by 100, thereby being able to calculate the resultant value as a measurement value variation ratio.

For example, when an interval set through a user (manager) terminal is 2 seconds,

measurement time from start to end of operation of a temperature sensor that is a current measuring sensor is a total of 2,000 seconds, a measurement value measured at 1520 seconds is 25° C., and a measurement value measured at 1,518 seconds is 36.6° C., a measurement value variation ratio can be calculated as 46.4% (100*(25−36.6)/25). In this case, when a ratio set through the user terminal is 30%, 1,518 seconds cannot be extracted as a comparison target time point because the measurement value variation ratio exceeds 30%.

Meanwhile, when a time point at which the measurement value variation ratio exceeds a preset ratio is not extracted because the time point does not exist, the time point extractor can extract sensing data corresponding to n certain time points in sensing data as comparison target time points.

In this case, a method of extracting n time point in the sensing data may use a program to which a programming language is applied, and the programming language may be python, Java, C, C++, JavaScript, Go, Ruby, Swift, Kotlin, PHP, C # (C Sharp), etc.

For example, a method of extracting n random time points in sensing data using python may extract n random time points after setting a time range in which a sensor is operated in the sensing data using a random module and a datetime module, or may use a Numpy module.

Further, another method of extracting n time points in the sensing data may randomly extract n time points in the sensing data by applying a Fisher-Yates shuffle algorithm to the time range of the sensing data.

Meanwhile, the ‘n’ of n time points that are extracted by the time point extractor means a natural number that may depend on an operating environment set through the user terminal and the certain time point may mean a time point randomly extracted without regularity from the entire time collected from sensing data.

The sensor unit can transmit sensing data that is a set of measurement values collected from several measuring sensors to the user terminal as well, and it is possible to classify a period in which the variation ratio of the sensing data does not exceed a preset variation ratio in correspondence to an interval set through the user terminal as a ‘standard state period’ and classify a period in which the variation ratio exceeds the preset variation ratio as an ‘abnormal state period’.

Meanwhile, the error determiner can calculate a sensor failure probability S_{TR} in accordance with the following [Equation 1].

$${S}_{TR} = Min ( \frac{\vert {T}_{ms 1} - {T}_{cs 1} \vert + \vert {T}_{ms 2} - {T}_{cs 2} \vert + … + \vert {T}_{msn} - {T}_{csn} \vert}{n \times {T}_{msav}} \times 100 + SE , 100 ) \qquad [ Equation 1 ]$$

(where S_{TR} is a sensor failure probability, Tₘₛ₁ is a measurement value of a measuring sensor at a first time point, Tₘₛ₂ is a measurement value of the measuring sensor at a second time point, Tₘₛ₃ is a measurement value of the measuring sensor at a third time point, Tₘₛₙ is a measurement value of the measuring sensor at an n-th time point, T_{cst1} is a measurement value of a comparison sensor at the first time point, T_{cst2} is a measurement value of the comparison sensor at the second time point, T_{cs3} is a measurement value of the comparison sensor at the third time point, T_{csn} is a measurement value of the comparison sensor at the n-th time point, Tₘₛₐᵥ is an average measurement value of the measuring sensor, and SE is an efficiency deviation of the measuring sensor).

The efficiency deviation SE of the measuring sensor can be calculated in accordance with the following [Equation 2] and average efficiency of the measuring sensor can be calculated in accordance with the following [Equation 3].

$$SE = {SE}_{av} - {SE}_{i} \qquad [ Equation 2 ]$$

(where SEₐᵥ is average efficiency of a measuring sensor and SEᵢ is initial efficiency of the measuring sensor).

$${SE}_{av} = \frac{100}{n} ( \frac{{W}_{{OUT}_{1}}}{{W}_{{IN}_{1}}} + \frac{{W}_{{OUT}_{2}}}{{W}_{{IN}_{2}}} + … + \frac{{W}_{{OUT}_{n}}}{{W}_{{IN}_{n}}} ) \qquad [ Equation 3 ]$$

(where W_{IN1} is power that is supplied to a measuring sensor at a first time point, W_{OUT1} is power that is measured when a measurement value sensed by the measuring sensor at the first time point is output as an electrical signal, W_{IN2} is power that is supplied to the measuring sensor at a second time point, W_{OUT2} is power that is measured when a measurement value sensed by the measuring sensor at the second time point is output as an electrical signal, W_{INn} is power that is supplied to the measuring sensor at an n-th time point, and W_{OUTn} is power that is measured when a measurement value sensed by the measuring sensor at the n-th time point is output as an electrical signal).

The n time points stated in [Equation 1] to [Equation 3] may mean the number of a plurality of time points at which a measurement value variation ratio of the sensing data counted through the time point extractor exceeds a preset ratio or time points randomly extracted through the time point extractor.

For example, when a first temperature that is the measuring sensor and a second temperature sensor that is the same model as the first temperature sensor and is a comparison sensor within a radius of 10 mm are provided, the sensor unit may sense the input and output voltages of the first temperature sensor and current consumption in the measuring sensor.

In this case, when three time points are extracted from the measuring sensor, voltages supplied from the first time point to the third time point are 4.9V, 5V, and 5V, the measuring sensor consumes currents of 1 mA, 0.9 mA, and 1.1 mA at corresponding time points, and voltages of 10 mV, 9 mV, and 11 mV are output, input power W_{IN1} that is supplied to the measuring sensor at the first time point can be calculated as 0.0049W(4.9V*0.001A), input power W_{IN2} at the second time point can be calculated as 0.0045W(5V*0.0009A), and input power W_{IN3} at the third time point can be calculated as 0.0055W(5V*0.0011A). Further, output power W_{OUT1} that is output from the measuring sensor at the first time point can be calculated as 0.00001W(0.01V*0.001A), output power W_{OUT2} at the second time point can be calculated as 0.000081W(0.009V*0.0009A), and output power W_{OUT3} at the third time point can be calculated as 0.0000121W(0.011V*0.0011A).

Further, the average efficiency SEₐᵥ of the measuring sensor is 0.2 (100/3*(0.00001/0.0049+0.000081/0.0045+0.0000121/0.0055)) on the basis of [Equation 2], and when the initial efficiency SEᵢ provided by the manufacturer of the measuring sensor is 0.2%, the efficiency deviation of the measuring sensor can be calculated as 0 on the basis of [Equation 3].

The lower the calculated average efficiency SEₐᵥ, the more efficient sensor the

measuring sensor is determined as, and the lower the calculated average efficiency SEₐᵥ, the more efficient sensor the measuring sensor is determined as, and the higher the calculated value is than the initial efficiency, the higher the failure probability in an electrical region of a sensor can be determined.

Meanwhile, when the initial efficiency SEᵢ of the measuring sensor is not provided, efficiency measured under a preset condition through the sensor unit may be set as initial efficiency SEᵢ.

Further, sensing data accompanying operation of the first temperature sensor (measuring sensor) may be collected from 0 second to 2,700 seconds. In this case, an average measurement value of the first temperature sensor may be 35° C. and measurement values measured at three time points randomly extracted through a program may be extracted as 29° C. (485 seconds), 35° C. (1893 seconds), 41° C. (2021 seconds).

Further, when measurement values measured at the same time points as the first temperature sensor by a second temperature sensor (comparison sensor) that has operated simultaneously with the first temperature sensor are respectively 30.1° C. (485 seconds), 32.5° C. (1893 seconds), 43° C. (2021 seconds), the failure probability of the first temperature sensor may be calculated as about 5.33% (Min ((|29—30.1|+|35—32.5|+|41—43|)/(3*35)*100+0), 100) on the basis of [Equation 1].

As another example, the error determiner may calculate a sensor failure probability S_{TR} in accordance with the following [Equation 1-2] reflecting a weight according to the distance of the measuring sensor and the comparison sensor.

$${S}_{TR} = Min ( \frac{\vert {T}_{ms 1} - {T}_{cs 1} \vert + \vert {T}_{ms 2} - {T}_{cs 2} \vert + … + \vert {T}_{msn} - {T}_{csn} \vert}{n \times {T}_{msav}} \times {D}_{v} \times 100 + SE , 100 ) \qquad [ Equation 1 - 2 ]$$

(where, Dᵥ is a distance weight of a measuring sensor and a comparison sensor).

In this case, the distance value weight of the measuring sensor and the comparison sensor Dᵥ is applied in correspondence to a weight that is set through the user terminal and the weight may be changed.

Through this process, the error determiner can calculate a sensor failure probability S_{TR} using sensing data collected from the data collector, and may further include a communication unit that transmits a call signal, which includes failure check notification, replacement notification, etc. for the sensor, to the user terminal when the sensor failure probability S_{TR} exceeds a preset ratio.

In this case, the preset ratio of the sensor failure probability S_{TR} may be set as 40%, and may be reset as a ratio between 0 to 99%, depending on the kind and sensitivity of the sensor.

Therefore, according to the present disclosure, it is possible to provide a high current terminal for electronic circuit protection that includes a fusible element between sectional terminals and can be used for general purpose by combining materials and shapes for the element on the basis of the purpose of use because a resistance value and a melting point are determined on the basis of the material and the shape of the element.

Further, it is possible to provide a circuit protection system that can accurately determine whether there is an error in a sensor by diagnosing failure of the sensor using a comparison target time point and that includes a high current terminal for electronic circuit protection that induces stable operation of the system with the sensor determined as normally operating.

Although the present disclosure was described above through a limited embodiment with reference to the drawings, the present disclosure is not limited thereto and may be changed and modified in various ways from the specification by those skilled in the art. Accordingly, an embodiment of the present disclosure should be construed only on the basis of claims described below, and equal or equivalent modifications should be all construed as being included in the spirit of the present disclosure.

1. A high current terminal for electronic circuit protection, comprising:
a first sectional terminal into which a current flows from the outside;
a second sectional terminal transmitting a current flowing inside through the first terminal to the outside; and
an element coupled between the first sectional terminal and the second sectional terminal,
wherein the element disconnects the first sectional terminal and the second sectional terminal by melting when a current exceeding a preset condition flows inside through the first sectional terminal, and is formed to have a thickness that is equal to or less than thicknesses of the first sectional terminal and the second sectional terminal.

2. The high current terminal of claim 1, wherein a preset pattern is formed on a surface of the element, and
the pattern is any one of a line trimming pattern, a double line trimming pattern, a circular hole pattern, an elliptical hole pattern, and a Z-line trimming pattern.

3. The high current terminal of claim 1, wherein the element is coupled between the first sectional terminal and the second sectional terminal through any one manner of E-beam welding, hot-rolling bonding, cold-rolling bonding, and laser welding.

4. The high current terminal of claim 1, wherein the element includes:
a first metal layer provided to have a preset thickness; and
a second metal layer provided on a top of the first metal layer and made of a different material from the first metal layer.

5. The high current terminal of claim 4, wherein the second metal layer
is formed on the top of the first metal layer through at least any one method of dipping plating, metal melting and pouring, metal dip coating, electroplating, and chemical plating,
reduces disconnection time between the first sectional terminal and the second sectional terminal when a melting point of the second metal layer is lower than a melting point of the first metal layer, and
delays the disconnection time between the first sectional terminal and the second sectional terminal when the melting point of the second metal layer is higher than the melting point of the first metal layer.
